(19) United States
(12) Patent Application Publication
(10) Pub. No.: US 2014/0347157 A1
(43) Pub. Date: Nov. 27, 2014

(54) MAGNETIC DEVICE UTILIZING NANOCOMPOSITE FILMS LAYERED WITH ADHESIVES

(71) Applicant: GEORGIA TECH RESEARCH CORPORATION, Atlanta, GA (US)

(72) Inventors: Markondeya Raj Pulugurtha, Tucker, GA (US); Rao R. Tummala, Greensboro, GA (US); Venkatesh Sundaram, Alpharetta, GA (US); Nitesh Kumbhat, Atlanta, GA (US); Uppili Sridhar, Morgan Hill, CA (US); Joseph Ellul, San Jose, CA (US); Dibyajat Mishra, Atlanta, GA (US)

(73) Assignee: GEORGIA TECH RESEARCH CORPORATION

(21) Appl. No.: 14/239,113

(22) PCT Filed: Aug. 16, 2012
(86) PCT No.: PCT/US2012/051090

§ 371 Date: Aug. 1, 2014

Related U.S. Application Data
(60) Provisional application No. 61/523,990, filed on Aug. 16, 2011.

(51) Int. Cl. H01F 27/30; H01F 41/02

(52) U.S. Cl. CPC H01F 27/306; H01F 41/02
USPC 336/196; 29/602.1

(57) ABSTRACT

Exemplary embodiments provide a nanomagnetic structure and method of making the same, comprising a device substrate, a plurality of nanomagnetic composite layers disposed on the device substrate, wherein an adhesive layer is interposed between each of the plurality of nanomagnetic composite layers. Metal windings are integrated within the plurality of nanomagnetic composite layers to form an inductor core, wherein the nanomagnetic structure has a thickness ranging from about 5 to about 100 microns.

### CROSS-REFERENCE TO RELATED APPLICATION

This application claims the benefit of U.S. Provisional Patent Application Ser. No. 61/523,990, filed 16 Aug. 2011, which is incorporated herein by reference in its entirety as if fully set forth below.

### BACKGROUND

1. Field

The various embodiments of the present invention generally relate to nanomagnetic structures for high density inductors and other magnetic devices and processes for manufacturing the same.

2. Description of Related Art

High-density inductors are important for several system functions such as power convertors, power amplifiers, and power telemetry. Inductors can be the largest and heaviest components in a system board.

Applications such as power conversion require inductances of 1-20 microHenry (μH) in a 5 millimeter (mm)×5 mm substrate. Typical commercial power inductors consist of ferrite or metal toroids with metal windings around them. These components are bulky and cannot be easily integrated in a package. Therefore, they are assembled on the packages and boards as discrete components. This increases the size of the power modules and results in bulky systems. There is an increasing trend to convert these bulky inductors as thin or thick components integrated on a silicon, glass or organic substrate, along with other active or passive components. For example, power inductors can be integrated as thin-films on active silicon substrates with ICs. There is another trend to integrate thin-film inductors on a passive silicon, glass or organic substrate along with several other passive components that are interconnected to each other. This integrated passive device (IPD) is then mounted on an interposer, package or substrate. The key to any of these integration schemes is to transform the discrete bulky toroid inductors to integrated planar thin-film inductors.

Typical planar inductor fabrication techniques involve a sequential deposition of metal coil with electroplating, and magnetic core deposition followed by via formation and next-layer playing. To achieve large inductors in a small volume, there should be optimal partition between metal wire and the magnetic material surrounding it.

Size reduction is a direct result of the ability to capture the magnetic flux in a much smaller volume using a high-frequency magnetic material. The main reason for absence of inductor miniaturization is lack of high permeability, low loss materials at high frequencies with high saturation magnetization. Existing high permeability metals and alloys (Fe—Si, Fe—Ni, Fe—Co-based alloys), powder materials (magnetic particles embedded in the insulator matrix) and ferrites (e.g., NiFe₂O₄, Mn—Zn- and Ni—Zn-ferrites) cannot be used efficiently at high frequencies. On the other hand, high-frequency, low-loss magnetic materials do not have sufficiently high permeability. Incorporation of high permeability materials can reduce the required number of turns but induce other losses from eddy currents and dielectric losses.

One approach to make high density inductors is to make a coiled layer on a ferrite or other ferromagnetic film on a substrate. Previous researchers also showed reduction of eddy current loss and high permeability at high frequencies through appropriate lamination of the magnetic core with insulating oxides or airgaps, which makes the process extremely complex and costly. Due to the relatively high permeability of these films, the laminations must be exceedingly fine (1-5 μm, i.e., on the order of the magnetic skin depth) for operation in the low-MHz regime. The typical disadvantage of these metallic alloys is linked to their low-electrical resistance, which can cause substantial eddy-current loss at high frequency, resulting in low efficiency. The other main disadvantage is the difficulty to scale the thickness of the multilayer laminate. Both the insulating layers and the magnetic films are deposited sequentially using thin-film deposition techniques such as sputtering, which makes it a very slow and expensive route to scale up the film thickness and achieve the required inductor performance.

Consequently, there is a need for high-density inductors that can be miniaturized, have sufficient permeability, and can be fabricated in a cost-effective way. It is to this need that the present invention is directed.

### BRIEF SUMMARY

Exemplary embodiments provide a nanomagnetic structure, comprising: a device substrate; a plurality of nanomagnetic film or composite layers disposed on the device substrate, wherein an adhesive layer is interposed between each of the plurality of nanomagnetic composite layers, and metal windings integrated within the plurality of nanomagnetic composite layers to form an inductor core, wherein the nanomagnetic structure has a thickness ranging from about 5 to about 100 microns. The nanomagnetic composite layers are magnetically oriented so that the inductor benefits from the properties in the hard axis, such as low coercivity and high field anisotropy (or DC saturation field). The metal windings can be formed around the nanomagnetic-adhesive laminate as a toroid structure. In this case, it is beneficial if the DC magnetic field from the current in the coil is along the hard-axis. Conversely, the nanomagnetic-adhesive laminate can be formed around the metal winding, which is sometimes referred to as a “pot-core”/“race-track” structure. The embodiments apply to both a nanomagnetic film and nanomagnetic composite with adhesive laminates.

The inductor is designed such that the magnetization is in the hard-axis in order to prevent the inductor saturation at low currents. Magnetization in the hard direction increases the frequency and DC saturation currents over which high permeability is maintained.

Other exemplary embodiments provide a method of fabricating a nanomagnetic structure, comprising: (a) depositing a nanomagnetic composite film on a carrier substrate; (b) bonding the nanomagnetic composite film onto a substrate device using an adhesive layer; (c) removing the carrier substrate; (d) repeating steps (a)-(c) to achieve a predetermined nanomagnetic composite structure thickness ranging from about 5 to about 100 microns; (e) patterning the nanomagnetic composite film; and (f) integrating the patterned nanomagnetic composite film with metal windings to form an inductor core.

Other exemplary embodiments provide a method of fabricating a nanomagnetic structure, comprising: (a) depositing a nanomagnetic composite film on a carrier substrate; (b) bonding the nanomagnetic composite film onto an intermediate substrate using an adhesive layer; (c) removing the carrier substrate; (d) repeating steps (a)-(c) to achieve a predetermined thickness; (e) transferring the nanomagnetic composite film and adhesive layers onto a device substrate via the intermediate substrate; (f) removing the intermediate substrate; (g) patterning the nanomagnetic composite film; and (h) integrating the patterned nanomagnetic composite film with metal windings to form an inductor core.

Other exemplary embodiments provide dicing the intermediate substrate and re-arranging the diced pieces to form the device structure such as a toroid. All the directions can have the correct magnetic anisotropy with the hard axis properties to result in the best inductance density and quality form factor.

Other exemplary embodiments provide molding the nanomagnetic composite film into non-planar structures such as copper windings or inside a v-groove. In this embodiment, the nanomagnetic-adhesive laminate is first transferred onto a planar or v-groove substrate. The metal layer is then formed as coils on the planar nanomagnetic-adhesive laminate or inside the v-groove. A second magnetic layer is then transferred to close the magnetic loop around the metal layer.

### BRIEF DESCRIPTION OF THE FIGURES

FIG. 1 illustrates an exemplary embodiment of a partially-complete nanomagnetic structure.

FIGS. 2A-2B illustrate methods for fabricating exemplary embodiments of the nanomagnetic structure.

FIG. 3 illustrates an alternative method for fabricating exemplary embodiments of the nanomagnetic structure.

FIG. 4 illustrates another fabrication method for the nanomagnetic structure, which results in a toroid magnetic inductor structure.

FIG. 5 illustrates a more detailed method of integrating metal windings with a toroid nanocomposite pattern.

FIG. 6 illustrates a planar view of a nanomagnetic structure, wherein the nanocomposite film layer is patterned into a toroid.

FIG. 7 illustrates a method of fabricating a nanomagnetic structure, wherein the nanocomposite-adhesive layer is patterned into a “pot-core” or “race-track” pattern.

FIG. 8 illustrates a more detailed method of integrating metal windings with a “pot-core” or “race-track” nanocomposite pattern.

FIG. 9 illustrates a planar view of the nanomagnetic structure having a “pot-core” or “race-track” pattern.

FIG. 10 illustrates yet another planar view of the nanomagnetic structure having a “pot-core” or “race-track” pattern.

FIG. 11 illustrates a cross-sectional view of FIGS. 9 and 10.

FIGS. 12a and 12b illustrate planar views of the metal winding and the nanocomposite-adhesive layer around the metal winding, respectively, of a “pot-core” or “race-track” pattern.

FIG. 13 illustrates an exemplary embodiment of a nanocomposite structure integrated with a secondary electronic component.

FIG. 14 provides an SEM image of a three-layered nanomagnetic-adhesive film disposed on a device substrate.

FIG. 15 illustrates film transfer of FIG. 14 with a BCB glue layer.

FIGS. 16a and 16b illustrate nickel film on a silicon device substrate and Teflon coated copper foil, respectively, after transfer.

FIG. 17a illustrates another embodiment of a nickel film on a silicon device substrate after transfer.

FIG. 17b illustrates a magnified film-transfer image of FIG. 17a.

FIG. 17c illustrates a smooth coated copper foil after transfer.

FIG. 18 provides an SEM image of a transferred nickel film.

FIG. 19 graphically illustrates a magnetization curve of the film.

### DETAILED DESCRIPTION

Referring now to the figures, wherein like reference numerals represent like parts throughout the several views, exemplary embodiments of the present invention will be described in detail. Throughout this description, various components can be identified as having specific values or parameters, however, these items are provided as exemplary embodiments. Indeed, the exemplary embodiments do not limit the various aspects and concepts of the present invention as many comparable parameters, sizes, ranges, and/or values can be implemented.

It should also be noted that, as used in the specification and the appended claims, the singular forms “a,” “an,” and “the” include plural references unless the context clearly dictates otherwise. For example, reference to a component is intended also to include composition of a plurality of components. References to a composition containing “a” constituent is intended to include other constituents in addition to the one named. Also, in describing the preferred embodiments, terminology will be resorted to for the sake of clarity. It is intended that each term contemplates its broadest meaning as understood by those skilled in the art and includes all technical equivalents which operate in a similar manner to accomplish a similar purpose.

Values may be expressed herein as “about” or “approximately” one particular value, this is meant to encompass the one particular value and other values that are relatively close but not exactly equal to the one particular value. By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The various exemplary embodiments provide unique and novel nanomagnetic structures for high density inductors and other magnetic devices, and a method for making the same. Current high-density inductor fabrication routes require complex fabrication steps such as sequential sputtering of metal insulators or electroplating through complex molds, which can be costly. Nanomagnetic composites can eliminate these complex steps with superior high-frequency performance and lower losses. However, sputtered nanomagnetic films cannot achieve the target thickness because of its low deposition rate. An alternate structure comprising layered nanocomposite films held together by adhesive materials addresses this fundamental challenge. Further, exemplary embodiments of the layered nanocomposite structure allows for easier manufacturing by processing the nanocomposite films separately, and then transferring them onto a device substrate using adhesives. The process can be repeated multiple times to achieve a desired final thickness.

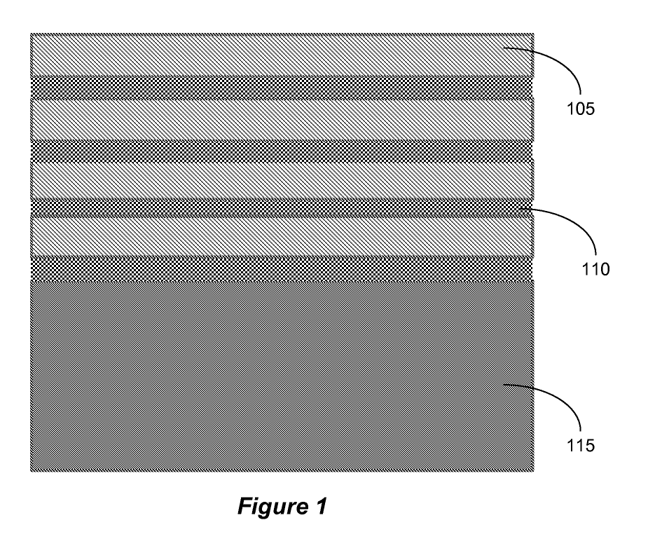

Referring to FIG. 1, there is shown an exemplary embodiment of a partially-complete nanomagnetic structure 100. As illustrated, a plurality of magnetic nanocomposite (“nanocomposite” or “nanomagnetic composite” or “nanomagnetic composite film” or “nanocomposite film”) layers 105 interposed with a plurality of adhesive layers 110 can be disposed onto a device substrate 115. The nanocomposite layers 105 and the adhesive layers 110 are alternatingly disposed, which allows for design flexibility necessary to achieve a desired final thickness. In exemplary embodiments, the nanocomposite layer 105 can range from 200 to 3000 nanometers (nm) in thickness, and the adhesive layer 110 can range from 0.2 to 5 μm (microns/micrometers). The nanocomposite layer 105 can be formed from liquid sol-gel coating and/or reduction heat treatment. Further, the number of layers of each preferably ranges from 5-25. It shall be understood that the embodiments are by no means limited to these dimensions, and that other dimensions can be utilized for the nanomagnetic structure 100. The combined thickness of the nanomagnetic structure preferably ranges from 5 to 100 μm, which fits within the desired miniaturization scale and sufficiently stores the magnetic properties of the device.

Magnetic softness of exchange-coupled nanomaterials can be much higher than that of their microscale materials. Recently, nano Fe-M-O (M=Hf, Zr, Si, Al or rare-earth metal element) thin films have been successfully manufactured via sputtering deposition. These are nanocomposites comprised of (<10 nm) magnetic nanoparticles surrounded by an amorphous insulator. Microferrites undergo magnetic relaxation at higher frequencies because of domain wall resonances. The frequency stability of nanocomposites is expected to be superior compared to microstructured counterparts. It has found that μ′ for Fe- and Co-based nanocomposites thin films can be as large as 500 and with essentially flat frequency response up to 1 GHz, which are much better than the magnetic properties of conventional ferrite and powder materials.

Therefore, the nanocomposite layer 105 can be made up of many materials, for example but not limited to, magnetic metal and alloy nanodomains separated by insulators. The metal can comprise iron, nickel, cobalt, or combinations thereof. Further, the insulator can comprise metal oxides of silica, hafnia, zirconia, or combinations thereof. Alternatively, the nanocomposite layer may comprise just a magnetic metal, for example but not limited to, iron, nickel, cobalt, or combinations thereof. The adhesive layer 110 can also be made of many materials, for example but not limited to, epoxy, benzocyclobutene (BCB), polyimidebenzoxazole, or combinations thereof.

As will be further described herein, the plurality of nanocomposite layers 105 (which may also be referred to as a “film”) and adhesive layers 110 can be subsequently patterned as a toroid, solenoid, or “pot-core” design and can be integrated with conductive metal windings.

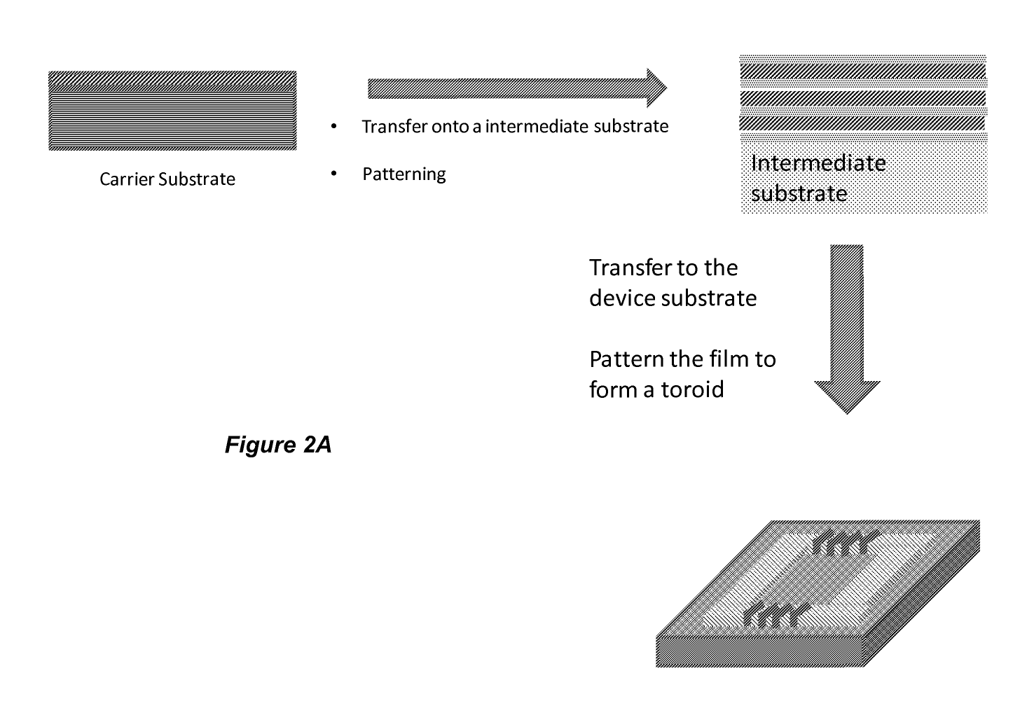

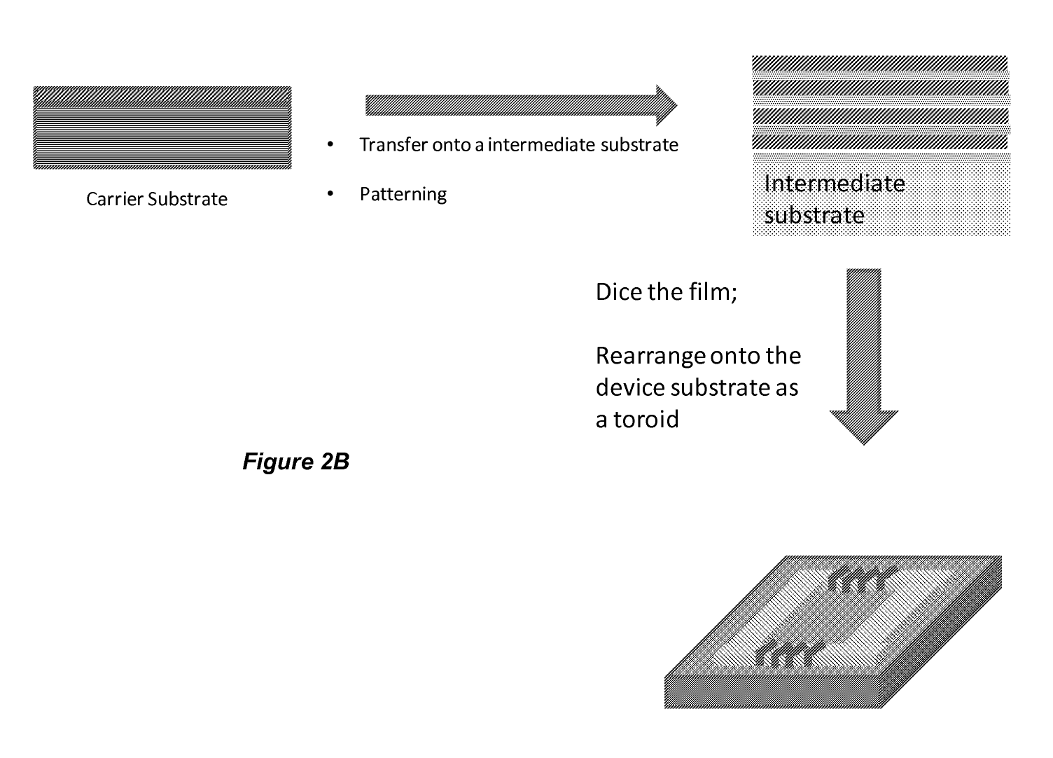

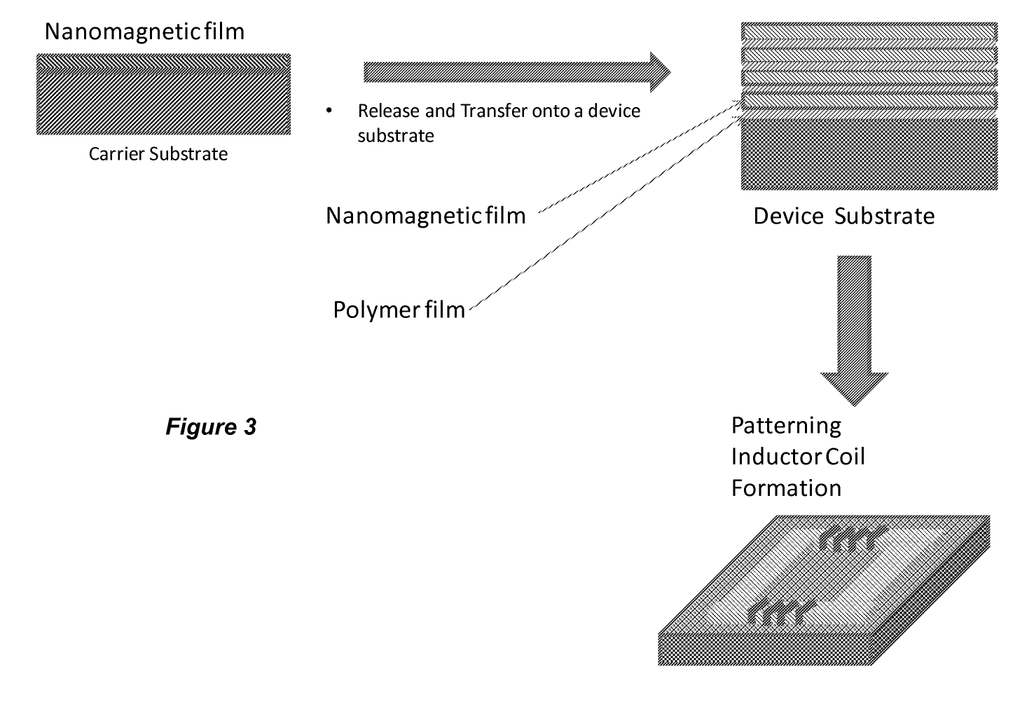

Referring to FIGS. 2A-2B and 3, there is shown two general methods for fabricating the exemplary embodiments of the nanomagnetic structure. Referring first to FIGS. 2A and 2B, a nanocomposite film can be disposed on a carrier substrate. It shall be understood that a plurality of nanocomposite films can be made on a plurality of respective carrier substrates at the same time. Stated another way, nanocomposite films can be deposited on side-by-side carrier substrates, which can speed up the overall manufacturing process. The carrier substrate can be, for example but not limited to, silicon, a silicon release layer, a copper foil, a copper release layer, Teflon, or a combination thereof. The nanocomposite film can then be transferred onto an intermediate substrate via the carrier substrate, wherein an adhesive layer is deposited in between each nanocomposite film layer. The nanocomposite film layers and the adhesive layers can then be transferred onto a device substrate via the intermediate substrate and subsequently patterned and integrated with conductive metal windings, as illustrated in FIG. 2A. Alternatively, the nanocomposite film can be subsequently diced and rearranged onto the device substrate as a toroid, as illustrated in FIG. 2B. The device substrate can be, for example but not limited to, silicon, organic laminate, glass or ceramic. In an alternative method, illustrated in FIG. 3, the intermediate substrate step can be eliminated from the method and the nanocomposite film layer can be transferred directly to the device substrate via the carrier substrate, wherein adhesive layers are deposited in between each nanocomposite film layer and subsequently patterned via laser or plasma etching or ablation techniques and integrated with conductive metal windings using metal plating techniques.

Referring to FIG. 4, there is shown yet another fabrication method for the nanomagnetic structure, which results in a toroid magnetic inductor structure. First, a nanocomposite film 405 is deposited on a carrier substrate 410 (FIG. 4a). As described above, this step can be carried out multiple times, sequentially or coincidingly relative to each other. The nanocomposite film 405 can be deposited using co-sputtering or sputtering techniques. Again, the carrier can be, for example but not limited to, silicon, a silicon release layer, a copper foil, a copper release layer, Teflon, or a combination thereof. In another step, a first layer of adhesive 415 may be deposited on a surface of a device substrate 420 (FIG. 4b). The device substrate 420 can be, for example but not limited to, silicon, organic laminate, glass or ceramic. The carrier substrate 410 can then be flipped such that the nanocomposite film 405 can be bonded to the device substrate 420 via the adhesive 415 (FIG. 4c). The adhesive 415 strengthens the bond between the nanocomposite film 405 and the device substrate 420. Contrastingly, there is a weaker bond between the nanocomposite film 405 and the carrier substrate 410, therefore allowing the carrier substrate 410 to be peeled away from the nanocomposite film 405 (FIG. 4d). This process can be repeated multiple times to form a nanocomposite structure of desired thickness (FIG. 4e). Although not illustrated in FIG. 4, an intermediate substrate can also be used as described above. The nanocomposite film 405 can then be patterned via laser or plasma etching or ablation techniques into the desired toroid or solenoid structure, wherein conductive metal windings are integrated thereon using metal plating techniques (FIG. 4f).

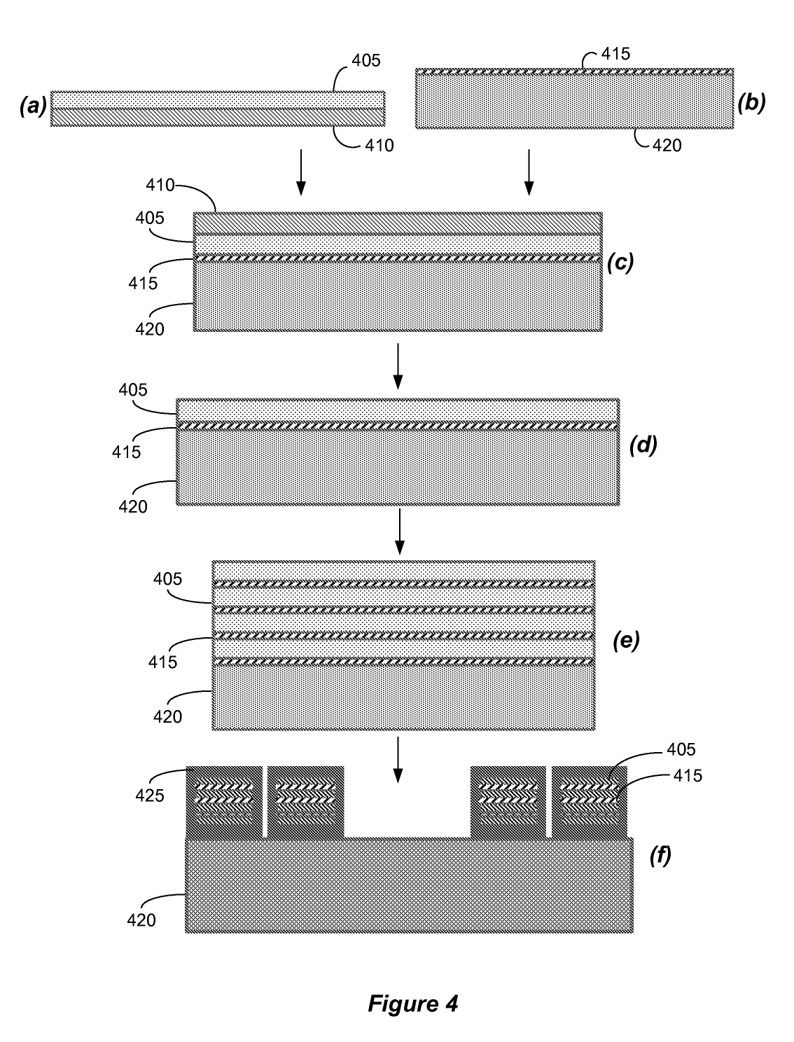

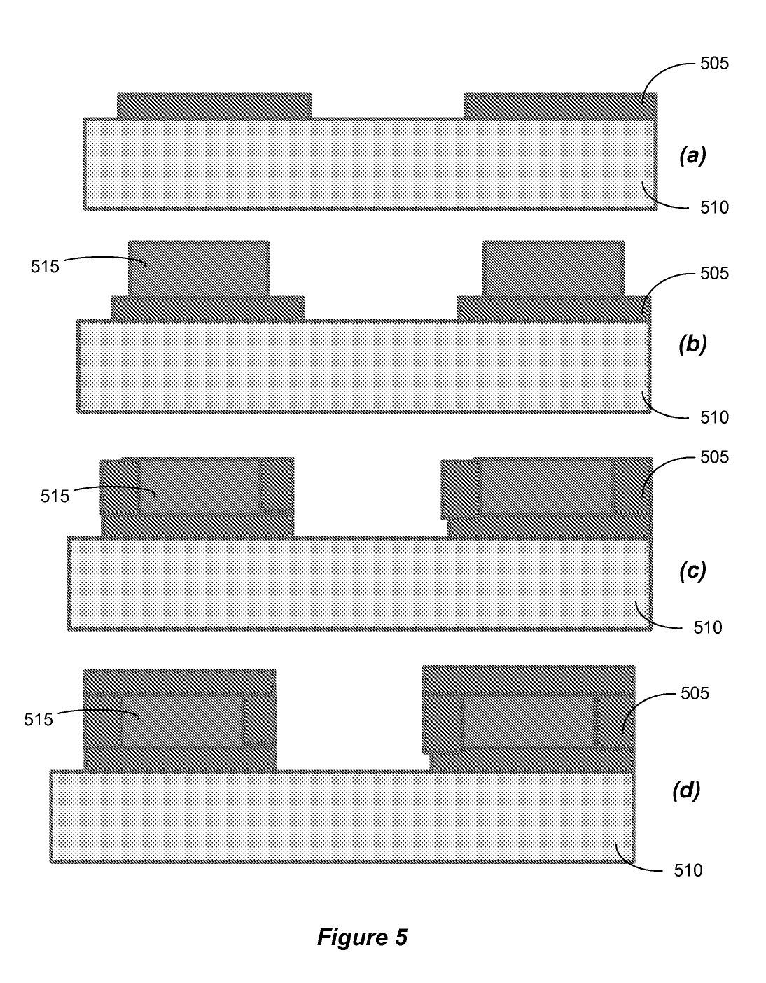

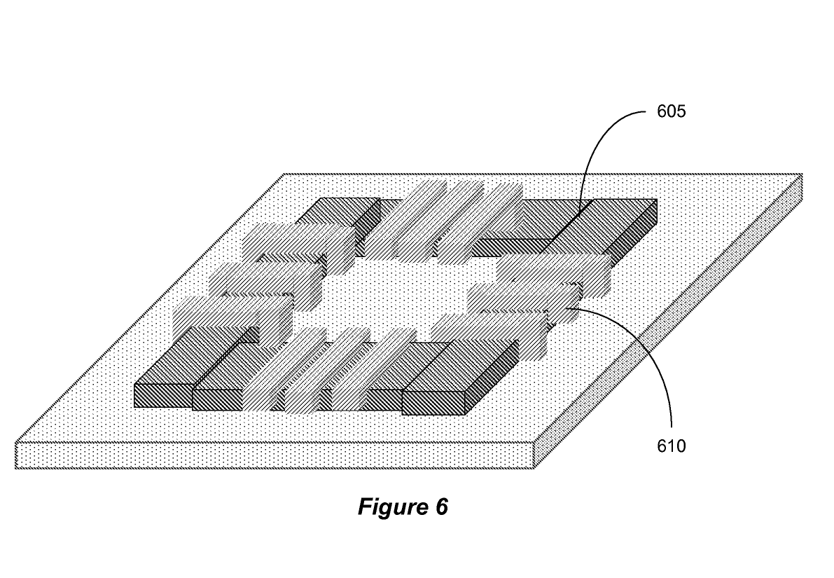

Referring to FIG. 5, there is shown a more detailed method of integrating metal windings with a toroid nanocomposite pattern. First, before the nanocomposite film and adhesive are deposited on the device substrate, a conductive metal layer 505 can be disposed on the device substrate 510 and patterned to create a portion of the winding (FIG. 5a). The nanocomposite-adhesive layer(s) 515 can then be deposited over the conductive metal winding 505 and patterned (FIG. 5b). Subsequently, additional conductive metal material can be deposited around the nanocomposite-adhesive layer(s) 515 such that the metal winding surrounds the nanocomposite-adhesive layer(s) (FIGS. 5c and 5d). Referring to FIG. 6, there is shown a planar view of a nanomagnetic structure, wherein the nanocomposite film layer 605 is patterned into a toroid pattern. As also illustrated in FIGS. 2A, 2B, and 3, the nanocomposite film layer forms a closed magnetic loop. In those Figures, however, the conductive metal windings are placed on two legs of the magnetic loop. In alternative embodiments, however, conductive metal windings 610 may be placed on all four legs of the magnetic loop, as illustrated in FIG. 6. It shall also be understood that the conductive metal windings can be of many shapes, for example but not limited to, rectangular, round, or combinations thereof.

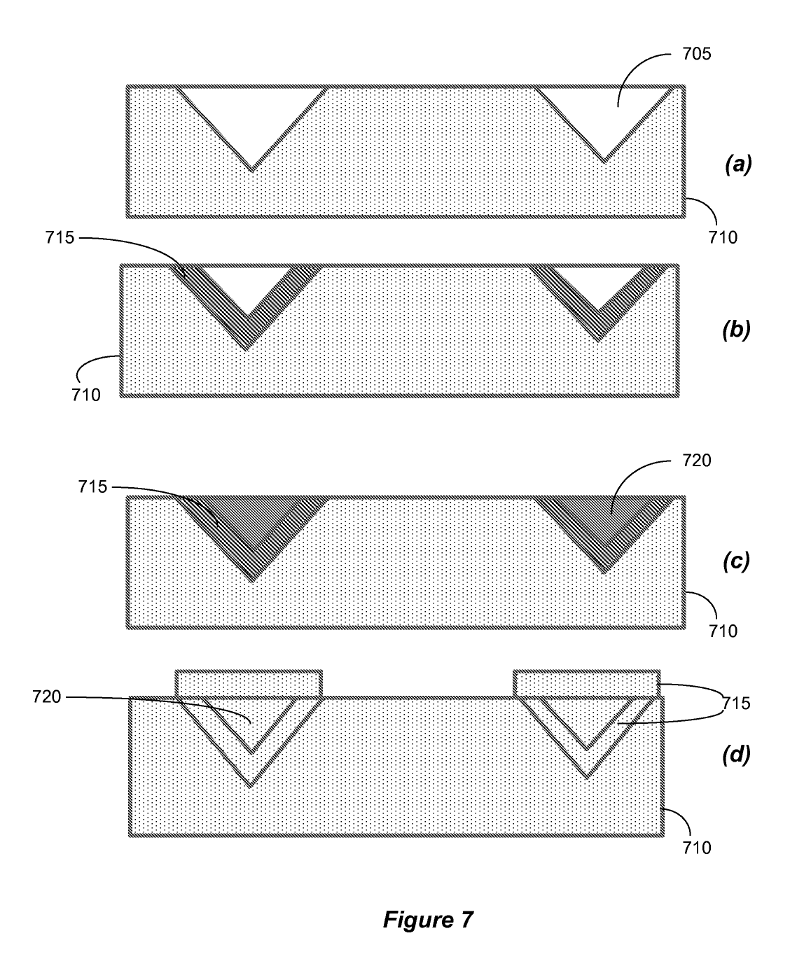

Referring to FIG. 7, there is shown a method of fabricating a nanomagnetic structure, wherein the nanocomposite-adhesive layer is patterned into a “pot-core” or “race-track” pattern. First, grooves 705 may be defined within a device substrate 710 (FIG. 7a). The bottom of a nanocomposite-adhesive layer 715 may then be deposited into the grooves (FIG. 7b), and a conductive metal layer, for example but not limited to, copper, may be deposited over the nanocomposite-adhesive layer to form the metal winding 720 (FIG. 7c). The top nanocomposite-adhesive layer may then be formed around the metal winding 720 to create the “pot-core” or “race-track” pattern (FIG. 7d).

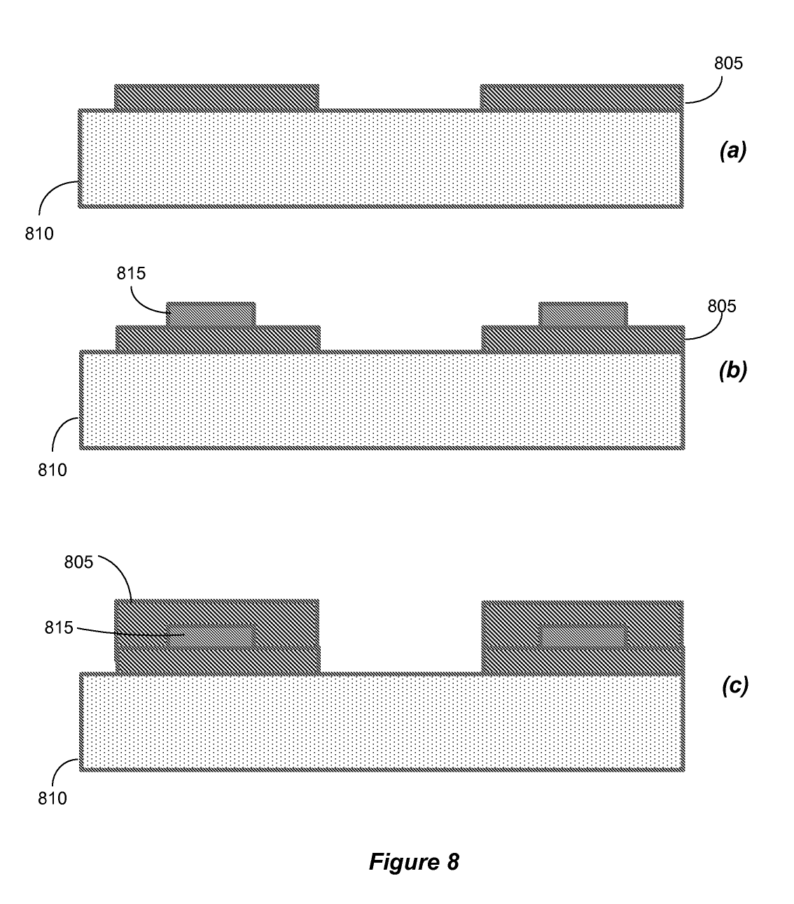

Referring to FIG. 8, there is shown a more detailed method of integrating metal windings with a “pot-core” or “race-track” nanocomposite pattern. First, the bottom of the nanocomposite-adhesive layer 805 can be patterned on the device substrate 810 (FIG. 8a). The conductive metal material can be patterned as coils to form the metal winding 815 (FIG. 8b), and the top of the nanocomposite-adhesive layer 805 can be molded to form a magnetic loop around the metal winding 815 (FIG. 8c).

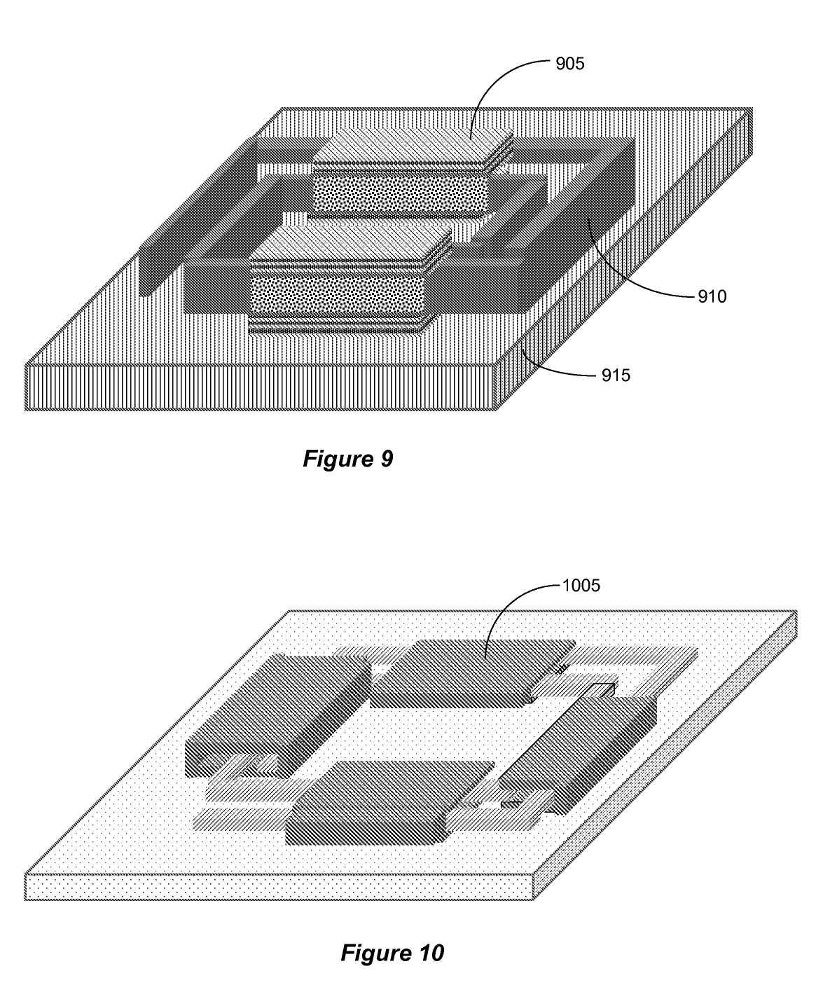

Referring to FIG. 9, there is shown a planar view of the nanomagnetic structure having a “pot-core” or “race-track” pattern. As illustrated, patterned nanocomposite-adhesive layers 905 are shown with metal windings 910 integrated within the nanocomposite-adhesive layers 905; both of which are disposed on a device substrate 915.

Referring to FIG. 10, there is shown yet another planar view of the nanomagnetic structure having a “pot-core” or “race-track” pattern. As illustrated, there are nanocomposite-adhesive layers 1005 on four legs of the magnetic loop as opposed to two legs, as illustrated in FIG. 9.

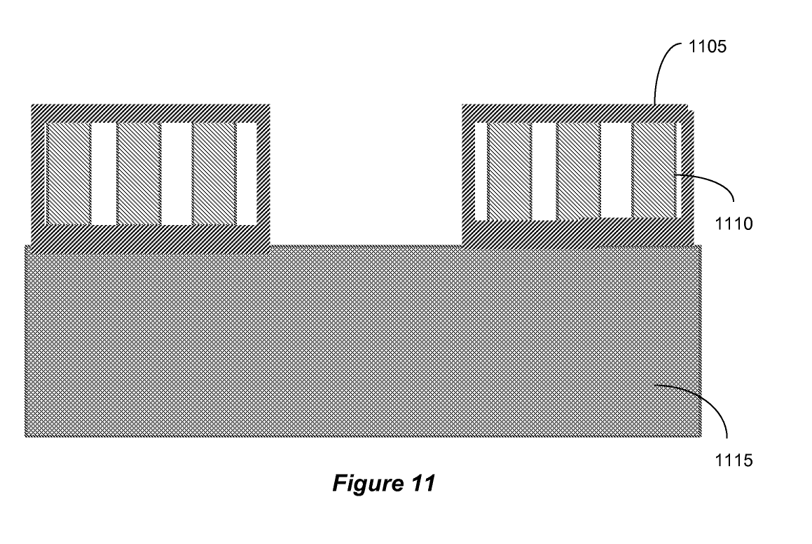

Referring to FIG. 11, there is shown a cross-sectional illustration of FIGS. 9 and 10. As illustrated, patterned nanocomposite-adhesive layers 1105 are shown with metal windings 1110 integrated within the nanocomposite-adhesive layers 1105; both of which are disposed on a device substrate 1115.

FIGS. 12a and 12b, illustrate planar views of the metal winding and the nanocomposite-adhesive layer around the metal winding, respectively, of a “pot-core” or “race-track” pattern.

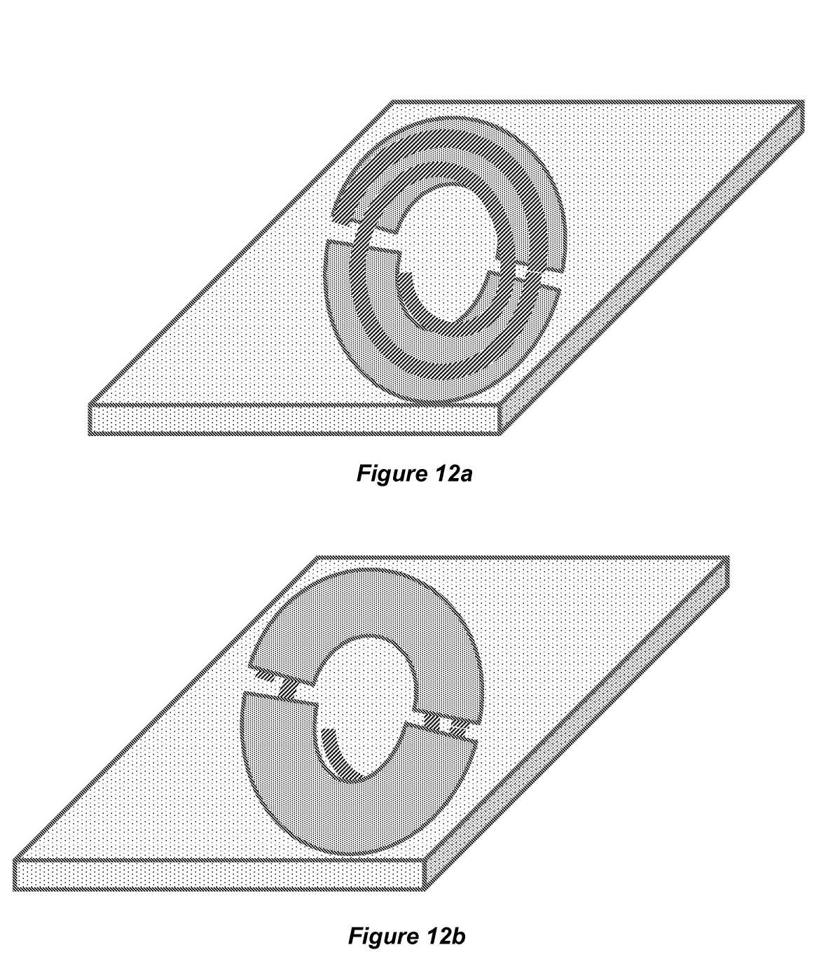

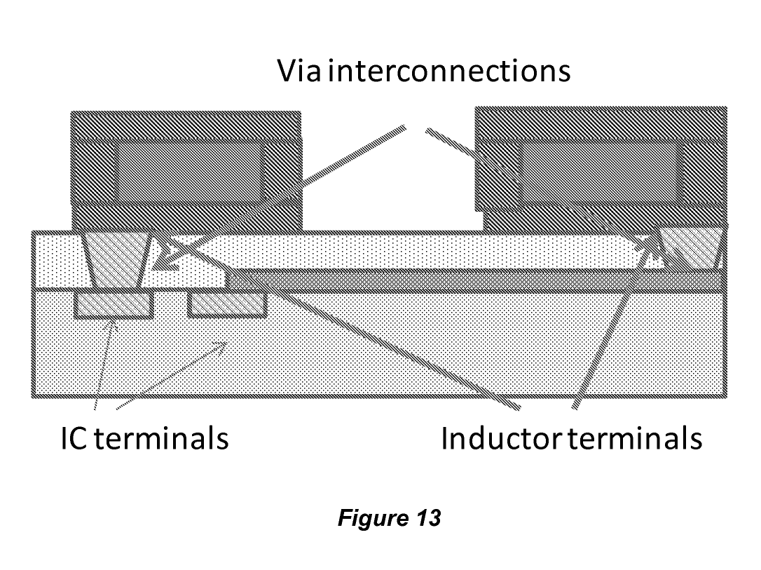

Further, referring to FIG. 13, there is shown an exemplary embodiment of a nanocomposite structure integrated with a secondary electronic component via IC or transistor terminals, inductor terminals, and via interconnections.

Instead of directly integrating the inductors on an active wafer as described in FIG. 13, the inductors can be formed separately on a passive silicon, glass or ceramic substrate (usually referred to as a discrete component or integrated passive device), which is then assembled on a interposer, package on an active wafer or inside a 3D IC.

For low-cost manufacturing, automated wafer scale tools can be used. These tools include, but are not limited to, wafer-to-wafer bonders for bonding the carrier substrate to the adhesive-coated substrate (i.e., the intermediate substrate or the device substrate). Similarly, an automated wafer peel tool can be used to release the carrier substrate.

Further, various low-cost techniques can be implemented to form the metal windings around the magnetic core, or form the spiral in case of pot-core inductors. For example:

1. Copper foil laminated and etch to form spiral windings: A copper foil is laminated, followed by patterning a photoresist etch-mask and acid etching to form the windings.

2. Wire-bonded copper or gold wire to form the windings around the toroid: A copper wire through a tool that functions similar to wire-bonder can be used to form the copper windings.

3) Printed silver to form the toroid inductors: An ink-jet printing or other similar printing cool can be used to form the metal windings.

4) Sequential copper plating to form the inductors: Copper plated windings can be implemented as a standard semi-additive process by depositing a seed layer, photoresist patterning, copper plating and seed layer removal.

### EXAMPLES

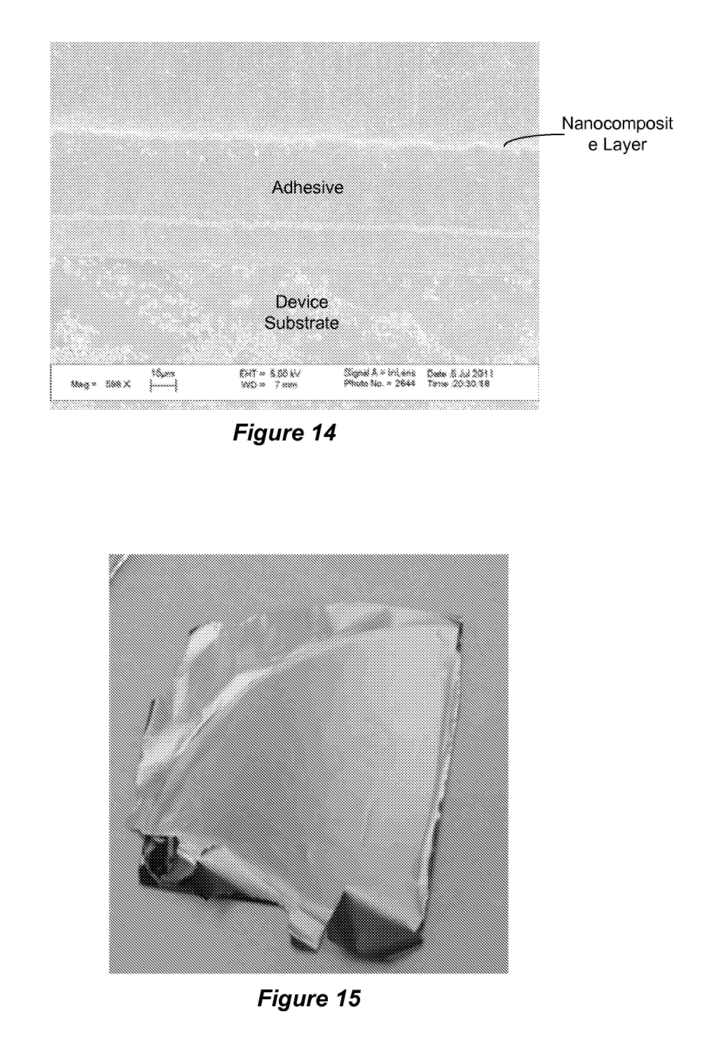

The various embodiments of the present invention are illustrated by the following non-limiting examples. The first set of films were done with epoxy dry films. Non-conductive epoxy films were first laid out on a device substrate. Sputtered films on a copper carrier were then bonded to the device substrate. The process was repeated twice, as illustrated in FIG. 14, to create a three-layered nanomagnetic-adhesive film. FIG. 15 illustrates the film transfer with a BCB glue layer. As described above, the multilayered structure is subsequently integrated with copper windings in various topologies.

The process was repeated with Teflon-coated copper. Teflon reduces the adhesion between the sputtered film and the carrier and helps easier film-transfer.

In the third demonstration of this technique, microetched and ultrasmooth copper foils were also used as carriers for the film transfer. The film transfer was found to be macroscopic defect-free with the smooth copper foils.

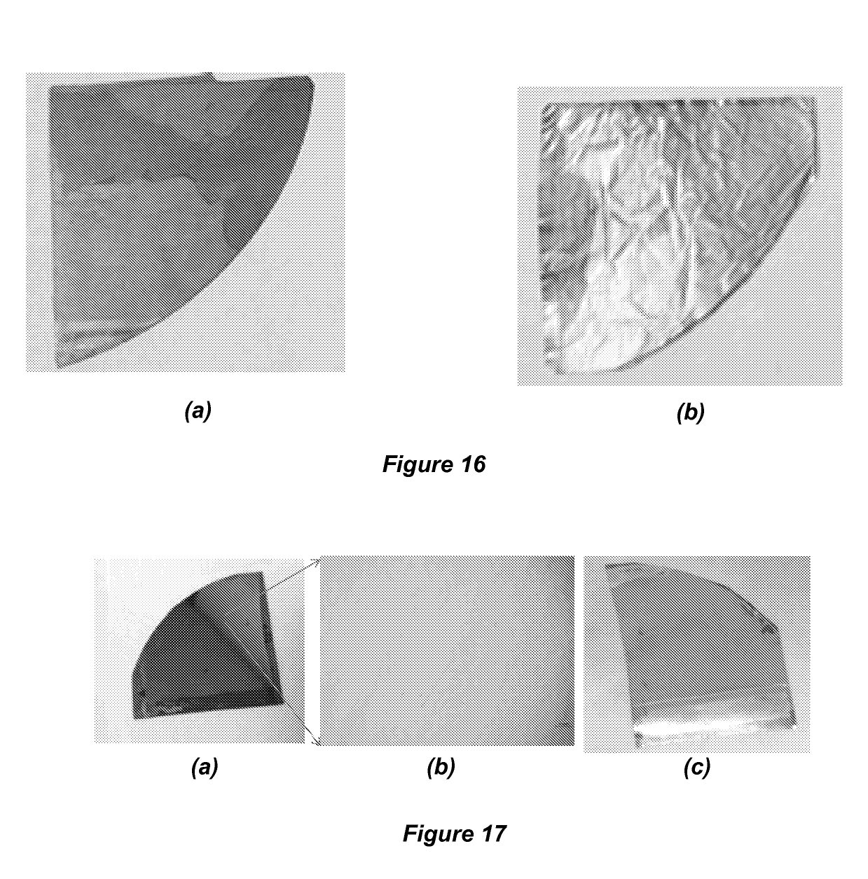

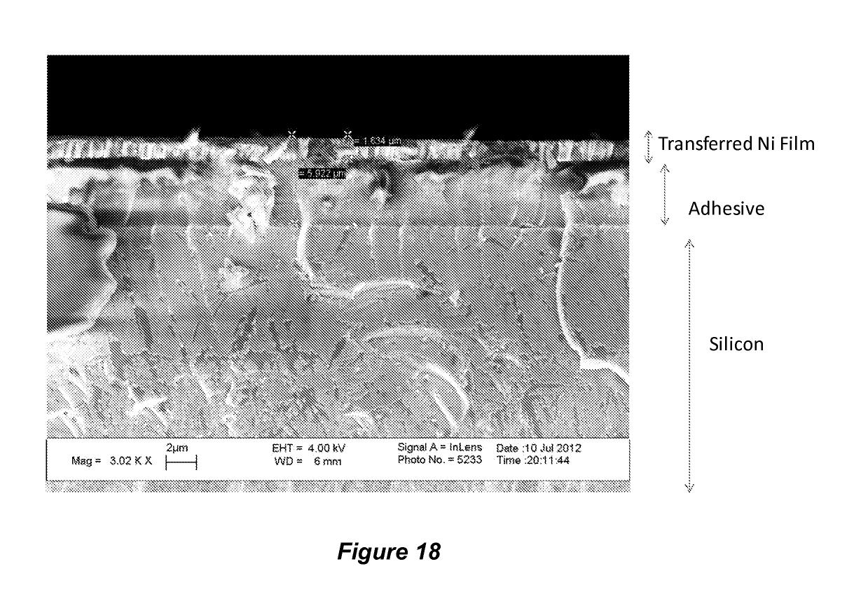

As illustrated in FIGS. 16a and 16b, there is shown nickel film on a silicon device substrate and Teflon coated copper foil, respectively after transfer. As illustrated in FIG. 17a, there is shown another embodiment of a nickel film on a silicon device substrate after transfer. FIG. 17b illustrates a magnified film-transfer image of FIG. 17a. FIG. 17c illustrates smooth coated copper foil after transfer. FIG. 18 provides an SEM image of the transferred nickel film.

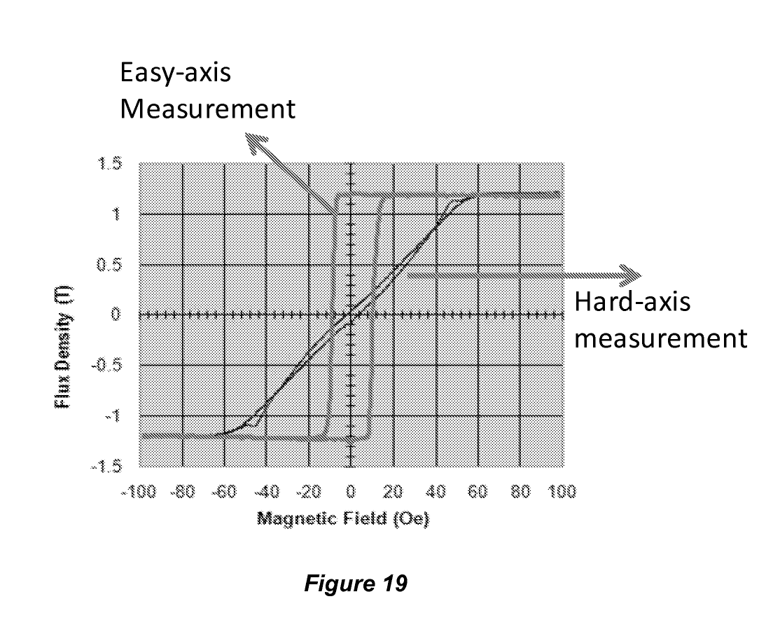

Toroid designs were simulated with the proposed nanomagnetic-adhesive laminate. In order to achieve an inductance density of 400 nH/mm² with 1 A current-handling and high Quality factor, a high permeability of 60-200 with Ms of 1 Tesla, and low coercivity is needed. A process for achieving the nanocomposite film on a carrier was also demonstrated. Cobalt and zirconium were co-sputtered with the appropriate Ar/O2 ratio to facilitate the formation of cobalt-zirconia nanocomposite film. FIG. 19 shows the magnetization curve of the film. From the curve it can be seen that the films possess soft magnetic properties with large in-plane anisotropy due to magnetic orientation along hard and easy axis. The films have very low coercivity of 3.7 Oe along the hard axis which will lead to low hysteretic loss. It has a high relative permeability of 80-100 and a high saturation magnetization field of ˜1 T, which meets the design requirements.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

1. A nanomagnetic structure, comprising:
a device substrate;
a plurality of nanomagnetic composite film layers disposed on the device substrate, wherein an adhesive layer is interposed between each of the plurality of nanomagnetic composite film layers; and
metal windings integrated within the plurality of nanomagnetic composite film layers to form an inductor core.

2. The structure of claim 1, wherein each of the plurality of nanomagnetic composite film layers has a thickness ranging from about 200 to about 3000 nanometers.

3. The structure of claim 1, wherein the adhesive layer has a thickness ranging from about 0.2 to about 4 microns.

4. The structure of claim 1, further comprising 5-25 nanomagnetic composite film layers.

5. The structure of claim 1, wherein the nanomagnetic structure has a combined thickness ranging from about 5 to about 100 microns.

6. The structure of claim 1, wherein each of the nanomagnetic composite film layers comprises a magnetic metal.

7. The structure of claim 6, wherein each of the nanomagnetic composite film layers further comprises alloy nanodomains separated by an insulator, wherein the insulator comprises metal oxides of silica, hafnia, zirconia, or combinations thereof.

8. (canceled)

9. The structure of claim 1, wherein the plurality of nanomagnetic composite film layers are patterned as a toroid or solenoid.

10. The structure of claim 1, wherein the plurality of nanomagnetic composite film layers are molded around the metal windings as a pot-core or race-track structure.

11-14. (canceled)

15. A method of fabricating a nanomagnetic structure, comprising:
(a) depositing a nanomagnetic composite film on a carrier substrate;
(b) bonding the nanomagnetic composite film onto a substrate device using an adhesive layer;
(c) removing the carrier substrate;
(d) repeating steps (a)-(c) to achieve a predetermined nanomagnetic structure thickness ranging from about 5 to about 100 microns;
(e) patterning the nanomagnetic composite film; and
(f) integrating the patterned nanomagnetic composite film with metal windings to form an inductor.

16-17. (canceled)

18. The method of claim 15, wherein the carrier substrate is removed using peeling techniques.

19. (canceled)

20. The method of claim 15, wherein the nanomagnetic composite film is patterned into a toroid or solenoid structure.

21. The method of claim 15, wherein the nanomagnetic composite film comprises a magnetic metal and alloy nanodomains separated by insulators, wherein the insulator comprises metal oxides of silica, hafnia, zirconia, or combinations thereof.

22-30. (canceled)

31. A method of fabricating a nanomagnetic structure, comprising:
(a) depositing a nanomagnetic composite film on a carrier substrate;
(b) bonding the nanomagnetic composite film onto an intermediate substrate using an adhesive layer;
(c) removing the carrier substrate;
(d) repeating steps (a)-(c) to achieve a predetermined thickness;
(e) transferring the nanomagnetic composite film and adhesive layers onto a device substrate via the intermediate substrate;
(f) removing the intermediate substrate;
(g) patterning the nanomagnetic composite film; and
(h) integrating the patterned nanomagnetic composite film with metal windings to form an inductor.

32. The method of claim 31, wherein the nanomagnetic composite film is deposited on the carrier substrate using co-sputtering or sputtering techniques.

33. (canceled)

34. The method of claim 31, wherein the carrier substrate is removed using peeling techniques.

35. (canceled)

36. The method of claim 31, wherein the nanomagnetic composite film is patterned into a toroid or solenoid structure.

37. The method of claim 31, wherein the nanomagnetic composite film from the intermediate substrate is diced and rearranged to form a toroid.

38. (canceled)

39. The method of claim 31, wherein the nanomagnetic composite film comprises a magnetic metal and alloy nanodomains separated by insulators.

40-43. (canceled)

44. The method of claim 31, wherein the nanomagnetic composite structure thickness ranges from about 5 to about 100 microns.

45-49. (canceled)
